(19) United States
(12) Patent Application Publication
(10) Pub. No.: US 2026/0359194 A1
(43) Pub. Date: Nov. 12, 2026

(54) SYSTEM AND METHOD FOR EXCLUDING UNAUTHORIZED CODE FROM A CODE SEGMENT

(71) Applicant: JPMorgan Chase Bank, N.A., New York, NY (US)

(72) Inventors: Mohankumar RAJAGOPALAN, Plainview, NY (US); Sonaleeka DASH, Bengaluru (IN); Amit Kumar MESHRAM, Romansville, PA (US)

(73) Assignee: JPMorgan Chase Bank, N.A., New York, NY (US)

(21) Appl. No.: 19/655,112

(22) Filed: Apr. 22, 2026

(30) Foreign Application Priority Data
May 6, 2025 (IN) 202511043749

(51) Int. Cl. G06F 11/3604

(52) U.S. Cl. CPC G06F 11/3608

(57) ABSTRACT

A methodology for excluding unauthorized code from a code segment is provided. The methodology includes: receiving at least one library of approved code; receiving at least one approved rule defining an approved use of code; first training a model to recognize, within a code sample, approved code from the at least one library of approved code, and use of code consistent with the at least one approved rule; testing the first trained model on a code sample; updating the at least one library and/or the at least one approved rule with additional content; second training the first trained model based on results of the testing and the additional content; applying the second trained model to a code segment in a pipeline; and first detecting, within the code segment, a first error relative to the at least one library of approved code and/or the at least one approved rule.

### CROSS-REFERENCE TO RELATED APPLICATIONS

This instant Application claims priority to India Patent Application 202511043749, entitled SYSTEM AND METHOD FOR EXCLUDING UNAUTHORIZED CODE FROM A CODE SEGMENT, filed May 6, 2025, the contents of which are expressly incorporated by reference in its entirety.

### TECHNICAL FIELD

This disclosure relates to methods and apparatuses for using an artificial intelligence / machine learning (AI/ML) model to exclude unauthorized code from a code segment in a timely and efficient manner.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

In code development, engineering teams are increasingly focused on rapid deliverables. It's crucial to have guardrails in place to enforce code standards at every stage and to detect deviations early, ensuring high-quality outcomes. However, code reviews often focus only on recent changes, rather than provide a comprehensive review. Also, most code review for custom entity standards are performed manually.

A technical problem with prior art automated code review by a code assistant product/service is that while they can help write efficient code, they do not identify and/or enforce custom coding standards established by the entity responsible for the code. For example, code may include third party code downloaded from the internet or provided by a code assistant, which while functional in the short term does not comport with the entity’s standards because it can cause significant technical debt and vulnerabilities during later development and deployment, making the error correction process more difficult, costly, or time-consuming.

More specifically, a technical problem with prior art automated code review systems, including code assistant products and services, is that such systems are generally optimized to evaluate syntactic correctness, compilation success, or generalized best practices, but lack the capability to reliably identify, interpret, and enforce organization-specific coding standards within a software development environment. In particular, these systems typically operate using broadly trained models or static rule sets that do not incorporate or dynamically adapt to custom constraints defined by an entity, such as proprietary architectural patterns, security policies, dependency restrictions, naming conventions, or performance requirements.

As a result, code generated or modified by such systems—including code incorporating third-party libraries, externally sourced snippets, or machine-generated implementations—may be functionally correct in isolation but non-compliant with the entity’s internal standards. This non-compliance introduces technical inconsistencies into the codebase, such as incompatible interfaces, unauthorized dependencies, inefficient resource utilization, or deviations from required execution patterns. These inconsistencies can propagate through interconnected components of the system, thereby degrading system reliability, maintainability, and performance.

Additionally, prior art systems do not provide mechanisms for detecting latent risks associated with the integration of non-compliant code at development time. For example, third-party or generated code may introduce hidden vulnerabilities, unverified execution paths, or resource contention issues that are not apparent during initial code generation or superficial review. Because such issues are not flagged early, they often manifest during later stages such as integration testing, deployment, or runtime operation, where remediation requires substantially more computational resources, developer effort, and system downtime.

Further, existing automated code assistants lack the ability to enforce compliance in a continuous and context-aware manner across evolving codebases. As software systems scale, the absence of automated enforcement of entity-specific standards results in cumulative technical debt, characterized by increased code complexity, reduced modularity, and decreased testability. This, in turn, leads to inefficient execution of automated build and deployment pipelines, increased frequency of runtime errors, and reduced effectiveness of downstream static and dynamic analysis tools.

Accordingly, there exists a technical problem in the field of automated code generation and review systems involving the inability of existing solutions to integrate entity-specific coding standards into the code evaluation process, detect non-compliant constructs in real time, and prevent the introduction of technically incompatible or vulnerable code into a software system. This deficiency results in measurable degradation of system performance, security, and maintainability, as well as increased computational overhead associated with later-stage error detection and correction.

There is accordingly a need for a methodology to identify and enforce entity standards in developed code before deployment.

### SUMMARY

The present disclosure, through one or more of its various aspects, embodiments, and/or specific features or sub-components, provides, among other features, various systems, servers, devices, methods, media, programs, and platforms for using an AI/ML model to exclude unauthorized code from a code segment in a timely and efficient manner.

According to an aspect of the present disclosure, a method is provided. The method includes: receiving at least one library of approved code; receiving at least one approved rule defining an approved use of code; first training a model to recognize, within a code sample, approved code from the at least one library of approved code, and use of code consistent with the at least one approved rule; testing the first trained model on a code sample; updating the at least one library and/or the at least one approved rule with additional content; second training the first trained model based on results of the testing and the additional content; applying the second trained model to a code segment in a pipeline; first detecting, within the code segment, a first error relative to the at least one library of approved code and/or the at least one approved rule; and locking out, in response to detecting the first error, deployment of the code segment.

The above method may have various features. The first detecting may identify code within the code segment that is not within the at least one library of approved code. The first detecting may identify use of code within the code segment that conflicts with any of the at least one approved rule. The at least one approved rule may include how the approved code reacts with supporting infrastructure and/or configurations of properties of the approved code. The method may further include: second detecting, within the code segment, a second error relative to the at least one library of approved code and/or the at least one approved rule, the second error having a lower criticality than the first error; establishing, in response to the second detecting, a predetermined time period for correction of the second error; and locking out, in response to an expiration of the predetermined time period without correction of the code segment, deployment of the code segment. The method may further include: repairing the locked out code segment; reversing the locking out, in response to the repairing; and deploying the repaired code segment. The repairing may include: modifying the code segment; applying the second trained model to the modified code segment; third determining, within the modified code segment by the second trained model, absence of unapproved code. The method may further include: receiving at least one library of unapproved code; and third training the second trained model to recognize, within a code sample, unapproved code from the at least one library of unapproved code; wherein the first detecting comprises detecting, within the code segment by the third trained model, code found within the at least one library of unapproved code.

According to another aspect of the present disclosure, a system is provided. The system includes a processor and a non-transitory computer readable memory storing instructions programmed to cooperate with the processor to perform operations. The operations include: receiving at least one library of approved code; receiving at least one approved rule defining an approved use of code; first training a model to recognize, within a code sample, approved code from the at least one library of approved code, and use of code consistent with the at least one approved rule; testing the first trained model on a code sample; updating the at least one library and/or the at least one approved rule with additional content; second training the first trained model based on results of the testing and the additional content; applying the second trained model to a code segment in a pipeline; first detecting, within the code segment, a first error relative to the at least one library of approved code and/or the at least one approved rule; and locking out, in response to detecting the first error, deployment of the code segment.

The above system may have various features. The first detecting may identify code within the code segment that is not within the at least one library of approved code. The first detecting may identify use of code within the code segment that conflicts with any of the at least one approved rule. The at least one approved rule may include how the approved code reacts with supporting infrastructure and/or configurations of properties of the approved code. The operations may further include: second detecting, within the code segment, a second error relative to the at least one library of approved code and/or the at least one approved rule, the second error having a lower criticality than the first error; establishing, in response to the second detecting, a predetermined time period for correction of the second error; and locking out, in response to an expiration of the predetermined time period without correction of the code segment, deployment of the code segment. The operations may further include: repairing the locked out code segment; reversing the locking out, in response to the repairing; and deploying the repaired code segment. The repairing may include: modifying the code segment; applying the second trained model to the modified code segment; third determining, within the modified code segment by the second trained model, absence of unapproved code. The operations may further include: receiving at least one library of unapproved code; and third training the second trained model to recognize, within a code sample, unapproved code from the at least one library of unapproved code; wherein the first detecting comprises detecting, within the code segment by the third trained model, code found within the at least one library of unapproved code.

According to yet another aspect of the present disclosure, a non-transitory computer readable media storing instructions programmed to cooperate with a processor to perform operations is provided. The operations include: receiving at least one library of approved code; receiving at least one approved rule defining an approved use of code; first training a model to recognize, within a code sample, approved code from the at least one library of approved code, and use of code consistent with the at least one approved rule; testing the first trained model on a code sample; updating the at least one library and/or the at least one approved rule with additional content; second training the first trained model based on results of the testing and the additional content; applying the second trained model to a code segment in a pipeline; first detecting, within the code segment, a first error relative to the at least one library of approved code and/or the at least one approved rule; and locking out, in response to detecting the first error, deployment of the code segment.

The above system may have various features. The first detecting may identify code within the code segment that is not within the at least one library of approved code. The first detecting may identify use of code within the code segment that conflicts with any of the at least one approved rule. The at least one approved rule may include how the approved code reacts with supporting infrastructure and/or configurations of properties of the approved code. The operations may further include: second detecting, within the code segment, a second error relative to the at least one library of approved code and/or the at least one approved rule, the second error having a lower criticality than the first error; establishing, in response to the second detecting, a predetermined time period for correction of the second error; and locking out, in response to an expiration of the predetermined time period without correction of the code segment, deployment of the code segment. The operations may further include: repairing the locked out code segment; reversing the locking out, in response to the repairing; and deploying the repaired code segment. The repairing may include: modifying the code segment; applying the second trained model to the modified code segment; third determining, within the modified code segment by the second trained model, absence of unapproved code. The operations may further include: receiving at least one library of unapproved code; and third training the second trained model to recognize, within a code sample, unapproved code from the at least one library of unapproved code; wherein the first detecting comprises detecting, within the code segment by the third trained model, code found within the at least one library of unapproved code.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to exclude unauthorized code from a code segment in a timely and efficient manner, in accordance with an embodiment.

FIG. 5 illustrates another exemplary flow chart of a process for using an AI/ML model to exclude unauthorized code from a code segment in a timely and efficient manner, in accordance with an embodiment.

FIG. 6 illustrates a data flow that corresponds to a process for using an AI/ML model to exclude unauthorized code from a code segment in a timely and efficient manner, in accordance with an embodiment.

FIG. 7 illustrates a data flow that corresponds to a process for using an AI/ML model to exclude unauthorized code from a code segment in a timely and efficient manner, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

A technical problem with prior art automated code review by a code assistant product/service is that while they can help write efficient code, they do not identify and/or enforce custom coding standards established by the entity responsible for the code. For example, code may include third party code downloaded from the internet or provided by a code assistant, which while functional in the short term does not comport with the entity’s standards because it can cause significant technical debt and vulnerabilities during later development and deployment, making the error correction process more difficult, costly, or time-consuming.

According to an aspect of the present disclosure, a method is provided. The method includes: receiving at least one library of approved code; receiving at least one approved rule defining an approved use of code; first training a model to recognize, within a code sample, approved code from the at least one library of approved code, and use of code consistent with the at least one approved rule; testing the first trained model on a code sample; updating the at least one library and/or the at least one approved rule with additional content; second training the first trained model based on results of the testing and the additional content; applying the second trained model to a code segment in a pipeline; first detecting, within the code segment, a first error relative to the at least one library of approved code and/or the at least one approved rule; and locking out, in response to detecting the first error, deployment of the code segment.

The above method may have various features. The first detecting may identify code within the code segment that is not within the at least one library of approved code. The first detecting may identify use of code within the code segment that conflicts with any of the at least one approved rule. The at least one approved rule may include how the approved code reacts with supporting infrastructure and/or configurations of properties of the approved code. The method may further include: second detecting, within the code segment, a second error relative to the at least one library of approved code and/or the at least one approved rule, the second error having a lower criticality than the first error; establishing, in response to the second detecting, a predetermined time period for correction of the second error; and locking out, in response to an expiration of the predetermined time period without correction of the code segment, deployment of the code segment. The method may further include: repairing the locked out code segment; reversing the locking out, in response to the repairing; and deploying the repaired code segment. The repairing may include: modifying the code segment; applying the second trained model to the modified code segment; third determining, within the modified code segment by the second trained model, absence of unapproved code. The method may further include: receiving at least one library of unapproved code; and third training the second trained model to recognize, within a code sample, unapproved code from the at least one library of unapproved code; wherein the first detecting comprises detecting, within the code segment by the third trained model, code found within the at least one library of unapproved code.

The above methodologies provide a technical improvement via a technical solution to the technical problems of traditional methodologies. The methodologies can identify and enforce coding standards established by the entity responsible for the code and locks out deployment of code that violates that deployment. This avoids significant technical debt and vulnerabilities during later development and deployment, saving the cost and time for corrective efforts. The multiple training steps for allowable code and rules allows for development and evolution of allowable v. unallowable code. The additional training step for specifically unallowable code provides the model with a lower power solution to identify and assess unallowable code as opposed to leaving the decision to the judgment of the model (which consumes more electrical power and computer resources).

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term "comprising" when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ± 5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

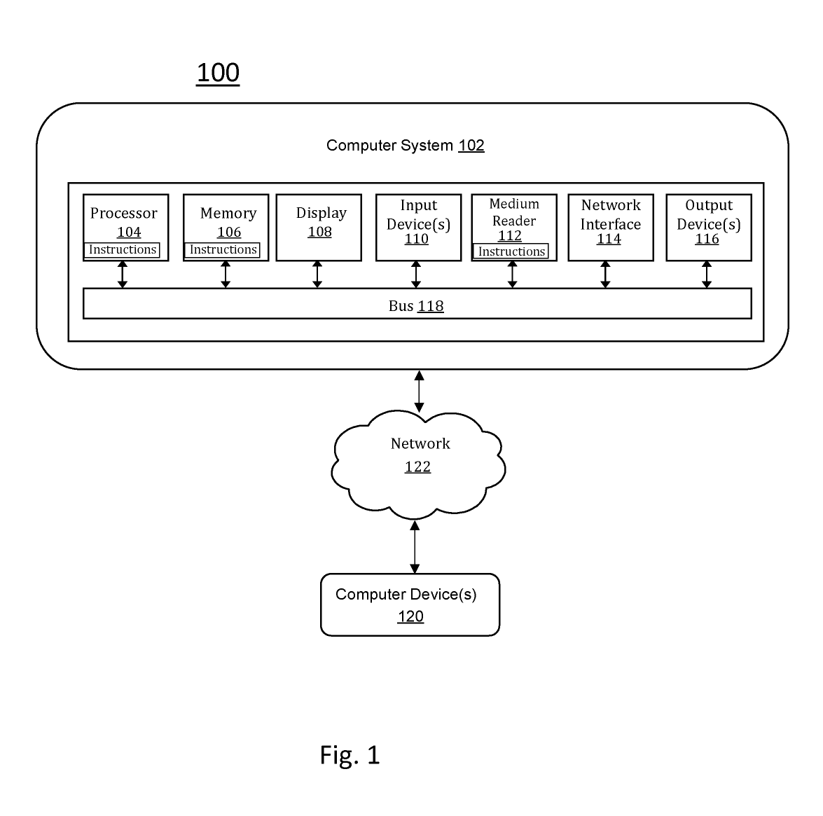

FIG. 1 is an exemplary system 100 for use in implementing a method for using an AI/ML model to exclude unauthorized code from a code segment in a timely and efficient manner, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain’t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

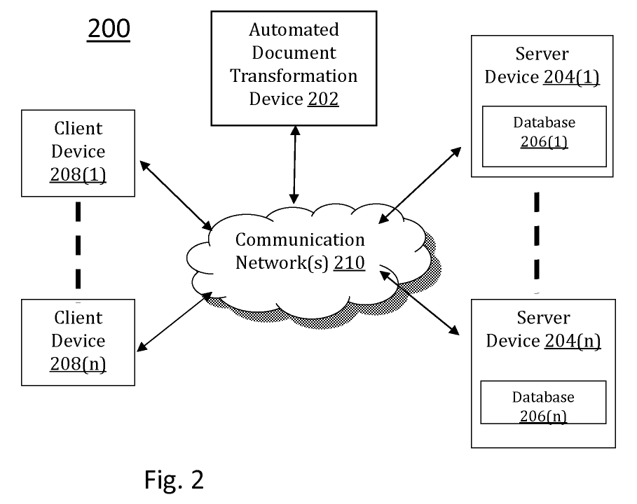

Referring to FIG. 2, a schematic of an exemplary network environment 200 for implementing a code exclusion device (CED) of the instant disclosure is illustrated.

In some embodiments, the above-described problems associated with conventional tools may be overcome by implementing an CED 202 as illustrated in FIG. 2 that may be configured for implementing a method for using an AI/ML model to exclude unauthorized code from a code segment in a timely and efficient manner, but the disclosure is not limited thereto.

The CED 202 may have one or more computer system 102s, as described with respect to FIG. 1, which in aggregate provide the necessary functions.

The CED 202 may store one or more applications that can include executable instructions that, when executed by the CED 202, cause the CED 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CED 202 itself, may be located in virtual server(s) running in a cloud-based computing environment rather than being tied to one or more specific physical network computing devices. Also, the application(s) may be running in one or more virtual machines (VMs) executing on the CED 202. Additionally, in one or more embodiments of this technology, virtual machine(s) running on the CED 202 may be managed or supervised by a hypervisor.

In the network environment 200 of FIG. 2, the CED 202 is coupled to a plurality of server devices 204(1)-204(n) that hosts a plurality of databases 206(1)-206(n), and also to a plurality of client devices 208(1)-208(n) via communication network(s) 210. A communication interface of the CED 202, such as the network interface 114 of the computer system 102 of FIG. 1, operatively couples and communicates between the CED 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CED 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CED 202 may be a standalone device or integrated with one or more other devices or apparatuses, such as one or more of the server devices 204(1)-204(n), for example. In one particular example, the CED 202 may be hosted by one of the server devices 204(1)-204(n), and other arrangements are also possible. Moreover, one or more of the devices of the CED 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CED 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the CED 202 that may efficiently provide a platform for implementing a method for using an AI/ML model to exclude unauthorized code from a code segment in a timely and efficient manner, but the disclosure is not limited thereto.

The client devices 208(1)-208(n) may run interface applications, such as standard web browsers or standalone client applications, which may provide an interface to communicate with the CED 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the CED 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the CED 202, the server devices 204(1)-204(n), or the client devices 208(1)-208(n), for example, may be configured to operate as virtual instances on the same physical machine. For example, one or more of the CED 202, the server devices 204(1)-204(n), or the client devices 208(1)-208(n) may operate on the same physical device rather than as separate devices communicating through communication network(s) 210. Additionally, there may be more or fewer CEDs 202, server devices 204(1)-204(n), or client devices 208(1)-208(n) than illustrated in FIG. 2. In some embodiments, the CED 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

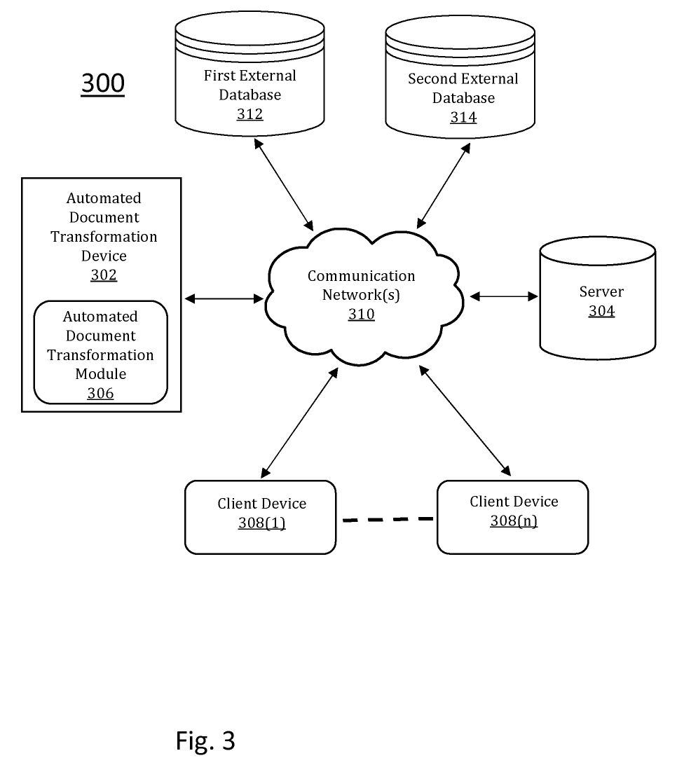

FIG. 3 illustrates a system diagram for implementing an CED 302 having an code exclusion module (CEM), in accordance with an embodiment.

As illustrated in FIG. 3, the system 300 may include an CED 302 within which an CEM 306 is embedded, a server 304, a first external database 312, a second external database 314, a plurality of client devices 308(1) … 308(n), and a communication network 310.

In some embodiments, the CED 302 including the CEM 306 may be connected to the server 304, and the database(s) 312 via the communication network 310. The CED 302 may also be connected to the plurality of client devices 308(1) … 308(n) via the communication network 310, but the disclosure is not limited thereto.

In an embodiment, the CED 302 is described and shown in FIG. 3 as including the CEM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the CEM 306 may be configured to receive real-time feed of data from the plurality of client devices 308(1) … 308(n) and secondary sources via the communication network 310.

The plurality of client devices 308(1) … 308(n) are illustrated as being in communication with the CED 302. In this regard, the plurality of client devices 308(1) … 308(n) may be “clients” (e.g., customers) of the CED 302 and are described herein as such. Nevertheless, it is to be known and understood that the plurality of client devices 308(1) … 308(n) need not necessarily be “clients” of the CED 302, or any entity described in association therewith herein. Any additional or alternative relationship may exist between either or both of the plurality of client devices 308(1) … 308(n) and the CED 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the CED 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The CED 302 may be the same or similar to the CED 202 as described with respect to FIG. 2, including any features or combination of features described with respect thereto.

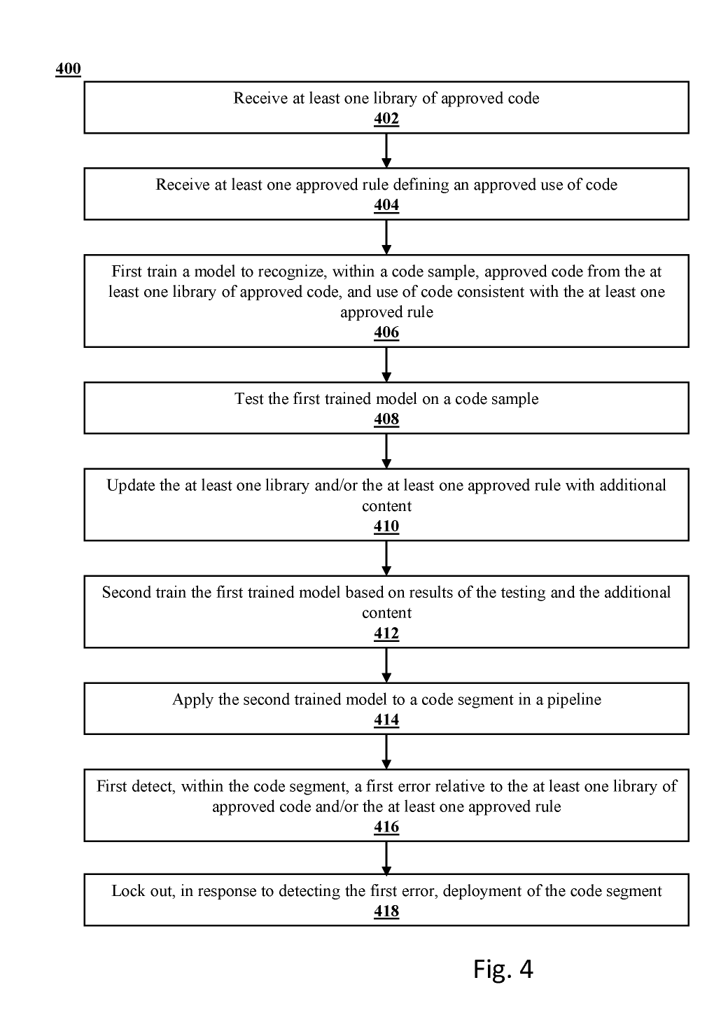

FIG. 4 illustrates an exemplary flow chart of a process 400 implemented by the CEM 306 of FIG. 3 for enablement of a system and a method for using an AI/ML model to exclude unauthorized code from a code segment in a timely and efficient manner, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving at least one library of approved code.

At step 404, the process 400 may include receiving at least one approved rule defining an approved use of code.

At step 406, the process 400 may include first training a model to recognize, within a code sample, approved code from the at least one library of approved code, and use of code consistent with the at least one approved rule.

At step 408, the process 400 may include testing the first trained model on a code sample.

At step 410, the process 400 may include updating the at least one library and/or the at least one approved rule with additional content;

At step 412, the process 400 may include second training the first trained model based on results of the testing and the additional content.

At step 414, the process 400 may include applying the second trained model to a code segment in a pipeline.

At step 416, the process 400 may include first detecting, within the code segment, a first error relative to the at least one library of approved code and/or the at least one approved rule.

At step 418, the process 400 may include locking out, in response to detecting the first error, deployment of the code segment.

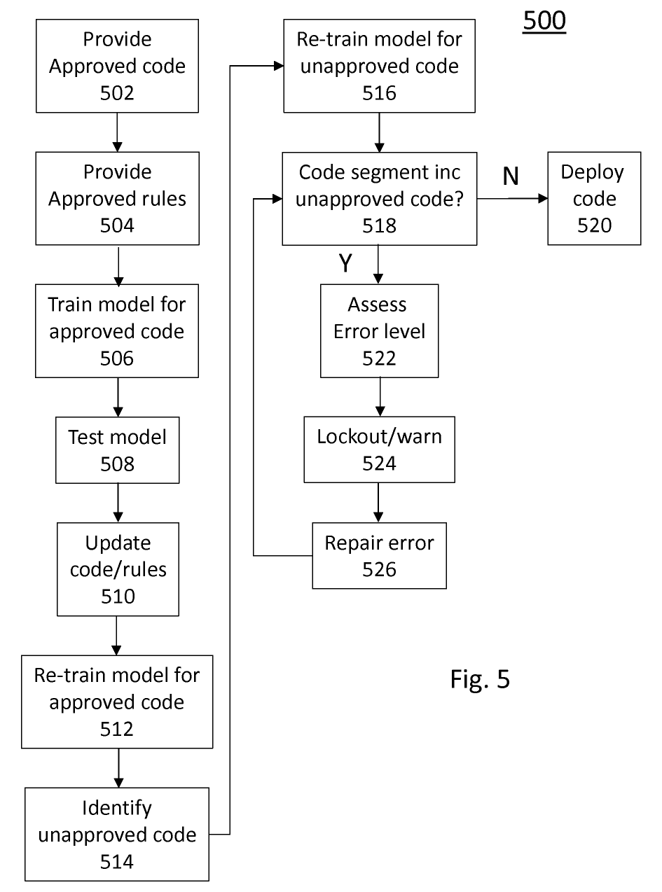

Referring now to FIG. 5, a process 500 is shown for producing standard complaint code. At step 502, one or more libraries of approved code are provided. Approved code comports with the user/organizational expectations and is permissible to use within code generated by the organization for deployment to commercial use.

At step 504, one or more approved rules defining approved use of the approved code are provided. As discussed in more detail below, code that conflicts with any of the one or more of the rules is not allowed and may lead to responsive action. Non-limiting examples of rules include how code interacts with supporting infrastructure, and configurations of properties of code. The invention is not limited to the specific nature of the approved rules.

At step 506, process 500 trains a first trained model to recognize, within a code sample, allowable code verses unallowable code. Allowable code will include code found in the approved libraries, and for which use of the code is consistent with the approved rules. By way of non-limiting example, code which is downloaded from the internet but not found within the libraries of approved code is unallowable code. In another non-limiting example, the presence of code that is within an approved library, but which interacts with an unapproved platform in conflict with a rule would be an example of unallowable code.

At step 508, process 500 tests the first trained model on code segments to identify allowable code v. unallowable code.

Since what is (or is not) approved code/rules may change over time, at step 510 the one or more libraries of approved code and the one or more approved rules can be updated.

At step 512, the first trained model is again trained based on (a) results of prior testing, and (b) with the updated code/rules, to arrive at a second trained model.

Over time, unapproved code, such as from third party internet sources, can be identified at step 514. Unapproved code may be obtained externally (e.g., by providing one or more libraries of unapproved code), or designated as unapproved by the process 500 when unapproved code is identified (e.g., at step 510 or other steps as appropriate) and add to one or more libraries of unapproved code as appropriate.

Unapproved code may be used at step 516 to again retrain the second trained model to provide a third trained model, such that the third trained model would be trained on both distinct approved code and unapproved code, rather than just approved code alone. Specifically designated unapproved code can automatically trigger certain levels of critical designations of errors for a code sample that includes the unapproved code, which may reduce overall AI computer resource and power consumption as discussed below.

At step 518, the third trained model is applied to a code segment that is in a development pipeline for ultimate deployment downstream in the pipeline to determine whether the code segment includes unapproved code.

If the third trained model does not detect any unapproved code or rules violation, then at step 520 the code may continue down the pipeline for further development and deployment as necessary.

If the third trained model detects any unapproved code or use of code in conflict with a rule, then at step 522 the third trained model assesses an error for the code at an appropriate level of criticality, e.g., critical or non-critical.

Designation of the level of the error (e.g., as critical or non-critical) may be based on the model making an independent determination. In the alternative, the third trained model may consult previously identified unapproved code per steps 514 and 516. The library(ies) of unapproved code may contain a criticality level (e.g., the presence of unapproved code A is critical, the presence of unapproved code B is non-critical). In the alternative, presence in a particular library at all may be considered critical, or there may be separate libraries for different levels of criticality (e.g., library A contains critical unapproved code, library B contains non-critical unapproved code).

Consulting the library(ies) of unapproved code to determine criticality rather than relying upon independent judgment of the third trained model uses less computer resources and consumes less electrical power, and is a specific technical advancement of this feature.

At step 524 the third trained model will react to the detected error based on the assessed level of criticality. If the error level is high enough (e.g., critical), then the model will issue a lock out command that prevents the code segment from advancing through the pipeline to deployment; this ensures that the unauthorized code never goes into commercial use until revised. If the error is a lower level of criticality, then a warning flag may be assigned to the code along with a time period for repair (e.g., one day); if the error is not corrected within the time period, the error level can be upgraded to higher level and the further development or development locked out as discussed above.

At step 526, the process repairs the code segment to remove the unauthorized code and/or correct the unauthorized use of the code. The repair may include modifying the code segment as appropriate and returning the modified code segment to step 518 to recheck the modified code. This process will loop until the code is designated as clean at step 518 and the code may proceed further down the development pipeline for deployment.

The invention is not limited to a binary critical/non-critical error list. There may be additional levels of error and responsive actions. For example, a mid-level error may be given a day to correct, while a low-level error may be given three days to correct.

The invention also does not require training on the unauthorized code, such that steps 514 and 516 can be omitted. In such a case, activity attributed to the third trained model would be undertaken by the second trained model.

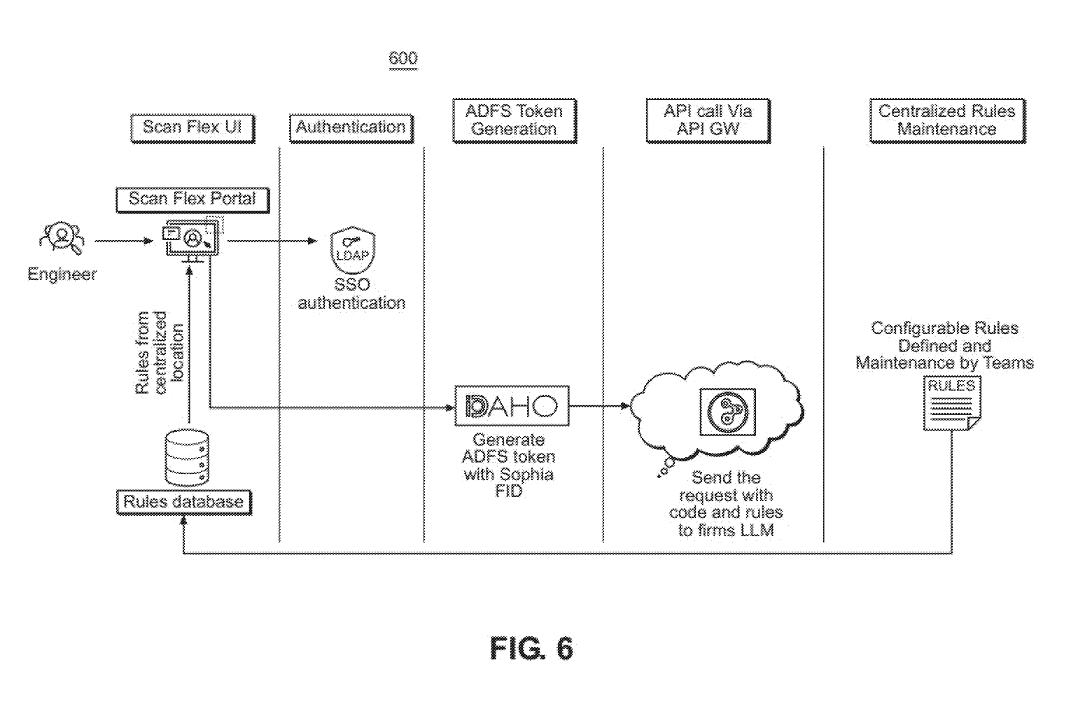

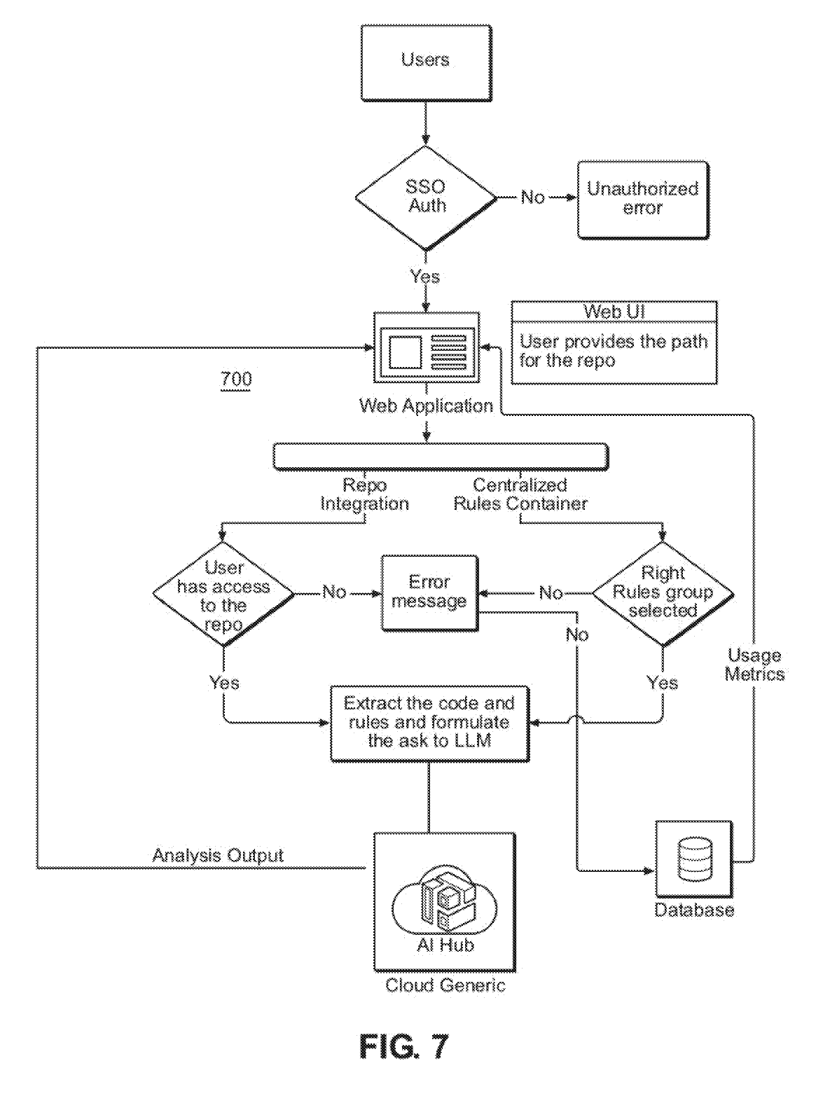

FIGS. 6 and 7 show processes 600 and 700, respectively, for data flows that corresponds to a process for using an AI/ML model to exclude unauthorized code from a code segment in a timely and efficient manner, in accordance with an embodiment.

The above methodologies provide a technical improvement via a technical solution to the technical problems of traditional methodologies. The methodologies can identify and enforce coding standards established by the entity responsible for the code and locks out deployment of code that violates that deployment. This avoids significant technical debt and vulnerabilities during later development and deployment, saving the cost and time for corrective efforts. The multiple training steps for allowable code and rules allows for development and evolution of allowable v. unallowable code. The additional training step for specifically unallowable code provides the model with a lower power solution to identify and assess unallowable code as opposed to leaving the decision to the judgment of the model (which consumes more electrical power and computer resources).

More specifically, the disclosed methodology provides a technical solution to the foregoing technical problem by enabling early-stage detection and exclusion of non-compliant code segments within a software development environment, thereby improving the operation of computer-based code generation and review systems. By identifying code that does not conform to entity-specific standards at or near the point of introduction into a codebase, the methodology prevents such code from being incorporated into downstream processing stages, including compilation, integration, and deployment pipelines.

This early-stage enforcement yields a technical improvement in the functioning of the overall software development system by reducing the propagation of incompatible or non-conforming code through interconnected system components. As a result, the system exhibits improved consistency in code structure and execution behavior, leading to more reliable compilation processes, fewer runtime exceptions, and enhanced interoperability among software modules.

Additionally, by locking out non-compliant code segments before they are further processed, the methodology reduces unnecessary consumption of computational resources associated with building, testing, and debugging defective or non-conforming code. This results in more efficient utilization of processing cycles, memory, and storage resources within automated build and continuous integration systems, thereby improving overall system performance.

The methodology further enhances system security and stability by preventing the introduction of unverified or unauthorized code constructs that may otherwise create vulnerabilities or unstable execution paths. By ensuring that only code conforming to predefined technical constraints is permitted to progress, the system reduces the likelihood of faults that could compromise execution integrity or require costly remediation at later stages.

Moreover, the approach improves the technical functioning of automated code review tools themselves by augmenting their capability to operate in a context-aware manner that reflects entity-specific requirements. This transforms such tools from generalized evaluators into systems capable of enforcing precise technical constraints, thereby increasing their effectiveness in maintaining system-wide code quality and integrity.

Accordingly, the disclosed methodology constitutes a technical solution that improves the performance, efficiency, and reliability of computer-implemented software development systems by addressing the technical deficiencies associated with prior art code review and generation technologies.

In some embodiments as disclosed above in FIGS. 1-6, technical improvements effected by the instant disclosure may include a platform to exclude unauthorized code from a code segment in a timely and efficient manner, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, the method comprising:
receiving at least one library of approved code;
receiving at least one approved rule defining an approved use of code;
first training a model to recognize, within a code sample, approved code from the at least one library of approved code, and use of code consistent with the at least one approved rule;
testing the first trained model on a code sample;
updating the at least one library and/or the at least one approved rule with additional content;
second training the first trained model based on results of the testing and the additional content;
applying the second trained model to a code segment in a pipeline;
first detecting, within the code segment, a first error relative to the at least one library of approved code and/or the at least one approved rule; and
locking out, in response to detecting the first error, deployment of the code segment.

2. The method of claim 1, wherein the first detecting identifies code within the code segment that is not within the at least one library of approved code.

3. The method of claim 1, wherein the first detecting identifies use of code within the code segment that conflicts with any of the at least one approved rule.

4. The method of claim 1, wherein the at least one approved rule includes how the approved code reacts with supporting infrastructure.

5. The method of claim 1, wherein the at least one approved rule includes configurations of properties of the approved code.

6. The method of claim 1, further comprising:
second detecting, within the code segment, a second error relative to the at least one library of approved code and/or the at least one approved rule, the second error having a lower criticality than the first error;
establishing, in response to the second detecting, a predetermined time period for correction of the second error;
locking out, in response to an expiration of the predetermined time period without correction of the code segment, deployment of the code segment.

7. The method of claim 1, further comprising:
repairing the locked out code segment;
reversing the locking out, in response to the repairing; and
deploying the repaired code segment.

8. The method of claim 7, wherein the repairing comprises:
modifying the code segment;
applying the second trained model to the modified code segment;
third determining, within the modified code segment by the second trained model, absence of an error relative to the at least one library of approved code and the at least one approved rule.

9. The method of claim 1, further comprising:
receiving at least one library of unapproved code; and
third training the second trained model to recognize, within a code sample, unapproved code from the at least one library of unapproved code;
wherein the first detecting comprises detecting, within the code segment by the third trained model, code found within the at least one library of unapproved code.

10. A system, comprising:
a processor,
a non-transitory computer readable memory storing instructions programmed to cooperate with the processor to perform operations comprising:
receiving at least one library of approved code;
receiving at least one approved rule defining an approved use of code;
first training a model to recognize, within a code sample, approved code from the at least one library of approved code, and use of code consistent with the at least one approved rule;
testing the first trained model on a code sample;
updating the at least one library and/or the at least one approved rule with additional content;
second training the first trained model based on results of the testing and the additional content;
applying the second trained model to a code segment in a pipeline;
first detecting, within the code segment, a first error relative to the at least one library of approved code and/or the at least one approved rule; and
locking out, in response to detecting the first error, deployment of the code segment.

11. The system of claim 10, wherein the first detecting identifies code within the code segment that is not within the at least one library of approved code.

12. The system of claim 10, wherein the first detecting identifies use of code within the code segment that conflicts with any of the at least one approved rule.

13. The system of claim 10, wherein the at least one approved rule includes how the approved code reacts with supporting infrastructure.

14. The system of claim 10, wherein the at least one approved rule includes configurations of properties of the approved code.

15. The system of claim 10, the operations further comprising:
second detecting, within the code segment, a second error relative to the at least one library of approved code and/or the at least one approved rule, the second error having a lower criticality than the first error;
establishing, in response to the second detecting, a predetermined time period for correction of the second error;
locking out, in response to an expiration of the predetermined time period without correction of the code segment, deployment of the code segment.

16. The system of claim 10, the operations further comprising:
repairing the locked out code segment;
reversing the locking out, in response to the repairing; and
deploying the repaired code segment.

17. The system of claim 16, wherein the repairing comprises:
modifying the code segment;
applying the second trained model to the modified code segment;
third determining, within the modified code segment by the second trained model, absence of an error relative to the at least one library of approved code and the at least one approved rule.

18. The system of claim 10, the operations further comprising:
receiving at least one library of unapproved code; and
third training the second trained model to recognize, within a code sample, unapproved code from the at least one library of unapproved code;
wherein the first detecting comprises detecting, within the code segment by the third trained model, code found within the at least one library of unapproved code.

19. A non-transitory computer readable memory storing instructions programmed to cooperate with a processor to cause the process to perform operations comprising:
receiving at least one library of approved code;
receiving at least one approved rule defining an approved use of code;
first training a model to recognize, within a code sample, approved code from the at least one library of approved code, and use of code consistent with the at least one approved rule;
testing the first trained model on a code sample;
updating the at least one library and/or the at least one approved rule with additional content;
second training the first trained model based on results of the testing and the additional content;
applying the second trained model to a code segment in a pipeline;
first detecting, within the code segment, a first error relative to the at least one library of approved code and/or the at least one approved rule; and
locking out, in response to detecting the first error, deployment of the code segment.

20. The system of claim 10, wherein the first detecting identifies (a) code within the code segment that is not within the at least one library of approved code and (b) use of code within the code segment that conflicts with any of the at least one approved rule.
